(19) United States
(12) Patent Application Publication
(10) Pub. No.: US 2026/0170650 A1
(43) Pub. Date: Jun. 18, 2026

(54) METHOD AND DEVICE FOR DATA AUGMENTATION FOR MEDICAL IMAGE ANALYSIS BASED ON ARTIFICIAL INTELLIGENCE

(71) Applicants: Seoul Women's University Industry-University Cooperation Foundation, Seoul (KR); KOREA ADVANCED INSTITUTE OF SCIENCE AND TECHNOLOGY, Daejeon (KR)

(72) Inventors: Helen HONG, Seoul (KR); Hansang LEE, Seoul (KR)

(73) Assignees: Seoul Women's University Industry-University Cooperation Foundation, Seoul (KR); KOREA ADVANCED INSTITUTE OF SCIENCE AND TECHNOLOGY, Daejeon (KR)

(21) Appl. No.: 19/419,998

(22) Filed: Dec. 15, 2025

(30) Foreign Application Priority Data
Dec. 16, 2024 (KR) 10-2024-0187227

(51) Int. Cl. G06T 7/00; G06V 10/764; G06V 10/774; G06V 10/82

(52) U.S. Cl. CPC G06T 7/0014; G06V 10/764; G06V 10/7747; G06V 10/82; G06T 2207/20081; G06T 2207/20084; G06T 2207/30041; G06T 2207/30088; G06T 2207/30096; G06T 2207/30196

(57) ABSTRACT

The present disclosure relates to a method and device for data augmentation for medical image analysis based on artificial intelligence, which proposes a data augmentation technique that improves medical image classification performance by combining a generative model (StyleGAN, ADM) and a mixed data augmentation (MixUp) approach, thereby solving the existing mode collapse problem and class imbalance problem, thereby improving accuracy in small and imbalanced data sets.

### CROSS-REFERENCE TO RELATED APPLICATIONS

A claim for priority under 35 U.S.C. § 119 is made to Korean Patent Application No. 10-2024-0187227 filed on Dec. 16, 2024 in the Korean Intellectual Property Office, the entire contents of which are hereby incorporated by reference.

### BACKGROUND

### 1. Technical Field

The present disclosure relates to a method and device for data augmentation for medical image analysis based on artificial intelligence.

### 2. Description of Related Art

Data augmentation (DA) plays a crucial role in medical image analysis, significantly improving the performance of machine learning models by increasing the diversity and quantity of training data. This is particularly important in medical images, where acquiring large and diverse datasets is often challenging due to privacy concerns, high costs, and the rarity of certain conditions.

Effective data augmentation requires mitigating problems such as overfitting and class imbalance to improve model generalization and robustness. However, standard augmentation methods, such as rotation, scaling, and flipping, may not be sufficient to capture the complex deformations and subtle differences present in medical images.

While traditional transformation-based data augmentation methods are widely used in medical image analysis, the increasing complexity of tasks is leading to the adoption of more advanced generative and blending-based data augmentation methods.

These data augmentation methods based on generative and mixture schemes use machine learning models to generate synthetic data that closely mimics real-world data sets, introducing new patterns and variations to enhance the training data.

Among these, the generative data augmentation methods include Generative Adversarial Networks (GANs) and diffusion models. These data augmentation methods significantly improve medical image analysis by increasing the diversity and quantity of training data. However, they also present challenges, such as mode collapse in GANs and the computational complexity of diffusion models, which can make training on small or population-balanced medical image datasets more difficult.

Meanwhile, the Mixture Data Augmentation (MixUp) method combines two images and labels to generate new samples. However, in small data sets or class imbalanced situations, it can be biased toward the dominant class, resulting in poor performance. Furthermore, these techniques struggle to effectively capture complex variations in medical imaging, hindering optimal model performance.

Therefore, there is a need to develop data augmentation techniques that leverage the strengths of both generative and mixture-based data augmentation methods while addressing their limitations in medical image classification.

### SUMMARY

The present disclosure is to propose a data augmentation technique that improves medical image classification performance by combining a generative model (StyleGAN, ADM) and a mixed data augmentation (MixUp) approach, thereby solving the existing mode collapse problem and class imbalance problem, thereby providing a method and device for medical image analysis based on artificial intelligence that improves accuracy in small and imbalanced data sets.

The problems to be solved by the present disclosure are not limited to the problems mentioned above, and other problems not mentioned will be clearly understood by those skilled in the art from the description below.

In an aspect of the present disclosure, a device for data augmentation for medical image analysis based on artificial intelligence may include a communication module configured to communicate with an external device; a memory configured to store at least one process for performing a data augmentation operation for medical image analysis based on artificial intelligence; and a processor configured to perform the data augmentation operation for medical image analysis based on artificial intelligence according to the process, wherein the processor is configured to: collect at least one real data obtained by photographing a lesion site of each of a plurality of patients, generate at least one synthetic data based on the at least one real data using a generative model, perform mixing different sample data sets generated based on at least a portion of the at least one real data and the at least one synthetic data using a mixture model, and provide a training data set generated by the mixing.

In another aspect of the present disclosure, a method for data augmentation for medical image analysis based on artificial intelligence performed by a device may include collecting at least one real data obtained by photographing a lesion site of each of a plurality of patients; generating at least one synthetic data based on the at least one real data using a generative model; performing mixing different sample data sets generated based on at least a portion of the at least one real data and the at least one synthetic data using a mixture model; and providing a training data set generated by the mixing.

In addition, a computer program stored in a computer-readable recording medium for executing a method for implementing the present disclosure may be further provided.

In addition, a computer-readable recording medium recording a computer program for executing a method for implementing the present disclosure may be further provided.

### BRIEF DESCRIPTION OF THE FIGURES

FIG. 1 is a diagram illustrating a system for providing a data augmentation service for medical image analysis based on artificial intelligence according to an embodiment of the present disclosure.

FIG. 2 is a diagram schematically illustrating a data processing procedure for augmenting data for medical image analysis based on artificial intelligence according to an embodiment of the present disclosure.

FIG. 3 is a diagram schematically illustrating a configuration of a data augmentation device for medical image analysis based on artificial intelligence according to an embodiment of the present disclosure.

FIG. 4 is a diagram schematically illustrating a configuration of a user terminal utilizing a data augmentation service for medical image analysis based on artificial intelligence according to an embodiment of the present disclosure.

FIG. 5 is a diagram illustrating a data augmentation method for medical image analysis based on artificial intelligence according to an embodiment of the present disclosure.

FIG. 6 shows diagrams illustrating examples of generative models according to an embodiment of the present disclosure.

FIG. 7 is a diagram illustrating an example of generating a training data set using a mixture model according to an embodiment of the present disclosure.

FIG. 8 is a diagram illustrating an example of real data and synthetic data of a DermaMNIST image according to an embodiment of the present disclosure.

FIG. 9 is a diagram illustrating an example of real data and synthetic data of a RetinaMNIST image according to an embodiment of the present disclosure.

FIG. 10 is a diagram illustrating an example of a visualization of the feature distribution of a training data set generated using at least some of the real and the synthetic data of FIG. 8, according to an embodiment of the present disclosure.

FIG. 11 is a diagram illustrating an example of visualizing the feature distribution of a training data set generated using at least some of the real data and the synthetic data of FIG. 9, according to an embodiment of the present disclosure.

### DETAILED DESCRIPTION

The advantages and features of the present disclosure, and methods for achieving them, will become clear with reference to the embodiments described in detail below along with the accompanying drawings. However, the present disclosure is not limited to the embodiments disclosed below and may be implemented in various different forms. The present embodiments are merely provided to ensure that the present disclosure is complete, and provided to fully convey the scope of the present disclosure to those skilled in the art to which the present disclosure pertains. The present disclosure is defined only by the scope of the claims.

The terminology used herein is for the purpose of describing embodiments and is not intended to limit the disclosure. As used herein, singular forms also include plural forms, unless specifically stated otherwise in the context. As used in the specification, “comprises” and/or “comprising” does not exclude the presence or addition of one or more other elements in addition to the mentioned elements. Throughout the specification, the same reference numerals refer to the same elements, and “and/or” includes each and every combination of the elements mentioned. Although “first”, “second”, etc. are used to describe various elements, it is to be understood that these elements are not limited by these terms. These terms are merely used to distinguish one element from another. Accordingly, it should be understood that a first element mentioned below may also be a second element within the technical scope of the present invention.

Unless otherwise defined, all terms (including technical and scientific terms) used in this specification may be used with meanings commonly understood by those skilled in the art to which this disclosure pertains. Additionally, terms defined in commonly used dictionaries are not to be interpreted ideally or excessively unless clearly specifically defined.

The same reference numerals refer to the elements throughout the present disclosure. This disclosure describes not all elements of the embodiments, and general descriptions or redundant descriptions in the embodiments in the technical field to which this disclosure belongs are omitted. The term “unit” or “module” used in the specification means a software, hardware component such as an FPGA or an ASIC, and the “unit” or “module” performs certain roles. However, the “unit” or “module” is not limited to software or hardware. The “unit” or “module” may be configured to be in an addressable storage medium and may be configured to play one or more processors. Thus, as an example, the “unit” or “module” includes components such as software components, object-oriented software components, class components, and task components, and processes, functions, properties, procedures, subroutines, segments of program code, drivers, firmware, microcode, circuits, data, databases, data structures, tables, arrays, and variables. The functions provided within the components and “parts” or “modules” may be combined into a smaller number of components and “parts” or “modules” or further separated into additional components and “parts” or “modules”.

Throughout the specification, when a part is said to be “connected” to another part, this includes not only the case where it is directly connected, but also the case where it is indirectly connected, and the indirect connection includes the connection via a wireless communication network.

Also, when a part is said to “include” a component, this does not mean that other components are excluded, unless otherwise specifically stated, but that other components may be included.

Throughout the specification, when a component is said to be “on” another component, this includes not only the case where the component is in contact with the other component, but also the case where another component exists between the two components.

The terms first, second, and the like are used to distinguish one component from another component, and the components are not limited by the aforementioned terms.

A singular expression includes a plural expression unless there is an obvious exception in the description.

The identifiers in each step are used for convenience of description and do not describe the order of each step, and each step may be performed in a different order than the stated order unless the description clearly describes a specific order.

The terms used in the following description are defined as follows.

Although described herein as a “service server,” this is a device for providing a pediatric brain perivascular space data augmentation service based on medical images, and may include various devices capable of performing computational processing. In addition, this service server may be connected/interlocked with a separate server, computer, and/or portable terminal to change settings or collect or analyze information and provide it, and its type and form are not limited.

The computer may include, for example, a notebook, a desktop, a laptop, a tablet PC, a slate PC, and the like equipped with a web browser.

Here, the server is a server that communicates with an external device to process information, and may include an application server, a computing server, a database server, a file server, a game server, a mail server, a proxy server, and a web server.

The portable terminal may include, for example, a wireless communication device that ensures portability and mobility, such as a PCS (Personal Communication System), a GSM (Global System for Mobile communications), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), a WiBro (Wireless Broadband Internet) terminal, a smart phone, and all kinds of handheld-based wireless communication devices, as well as wearable devices such as watches, rings, bracelets, anklets, necklaces, glasses, contact lenses, or head-mounted devices (HMDs).

In this specification, the artificial intelligence-based pre-learning model or service platform according to the present disclosure may be generated and provided by a computing device based on big data and artificial intelligence (AI) technology, and can be implemented using or referencing ICT (Information and Communication Technology) technologies such as virtual reality (VR), augmented reality (AR), and mixed reality (MR), extended Reality (XR), and blockchain technology for the security of medical information or personal information included therein. However, in this specification, a detailed description of the ICT technology related to the present disclosure is omitted by referring to known technologies.

Hereinafter, the operating principle and embodiments of the present disclosure will be described with reference to the attached drawings.

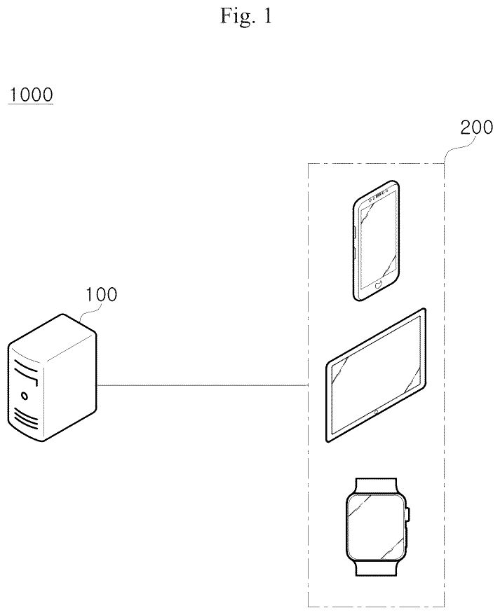

FIG. 1 is a diagram illustrating a system for providing a data augmentation service for medical image analysis based on artificial intelligence according to an embodiment of the present disclosure.

Referring to FIG. 1, a system for providing a data augmentation service for medical image analysis based on artificial intelligence (hereinafter, referred to as the “service provision system”) 1000 according to an embodiment of the present disclosure may include at least one of a service server 100 or a user terminal 200.

The service server 100 is a device for providing a data augmentation service for medical image analysis based on artificial intelligence (hereinafter, referred to as the “data augmentation service”) according to an embodiment of the present disclosure, that is, a data augmentation service providing device. For this purpose, the service server 100 may provide a separate web page and/or service platform (application), and each user terminal 200 may provide or receive various information/data for the data augmentation service based on the web page or service platform.

In addition, the service server 100 transmits and receives various data and/or information with the user terminal 200 or a separate external device (not shown) based on at least one communication scheme, thereby providing the user with a data augmentation service.

To provide the data augmentation service, the service server 100 may be connected to the user terminal 200 and collect or receive all information/data related to the data augmentation service, such as various notifications, requests, and information. Meanwhile, the service provision system 1000 may be linked (connected) to an electronic medical record system to collect and utilize various information for each patient. The electronic medical record system is a system configured to enable each medical professional or each medical institution to record and manage various information for each patient. When information for a specific patient is entered from a specific medical professional or a specific medical institution, all of this may be processed and managed as a database. Here, various information for each patient may include basic information such as personal information and physical information, as well as medical data (medical information) including at least one of medical history, treatment result, test result, or medical image. However, this is merely an example; additional patient information may be included or at least some may be excluded, and the stored data/information is not limited to the data/information listed above.

Thus, the service server 100 collects at least one medical data through the user terminal 200 and/or the electronic medical record system.

Specifically, the service server 100 collects at least one real data obtained by photographing a lesion site of each of a plurality of patients from the user terminal 200, and generates an augmented training data set based on the at least one of the real data collected previously, using the GenMix method, which applies both generative and mixed data augmentation methods.

In this way, GenMix integrates two data augmentation methods, preserving the stable learning process facilitated by the mixed data augmentation method while leveraging the pattern diversity introduced by the generative data augmentation method. This effectively mitigates the shortcomings of each method, while also improving overall model performance.

To provide the data augmentation service, the service server 100 may construct and be provided with at least one pre-trained model based on artificial intelligence. Furthermore, the service server 100 may continuously manage, that is, retrain and/or update, the constructed at least one learning model to improve its performance. For example, the pre-trained model based on artificial intelligence may include a generative model and a mixture model.

Meanwhile, the user terminal 200 is a terminal possessed by a user pre-registered with the service server 100 to utilize the data augmentation service provided by the service server 100, and at least one user terminal 200 may be included. To utilize the data augmentation service provided by the service server 100, each user may access a web page provided by the service server 100 through his or her own user terminal 200, or may install and provide a service platform (application).

To utilize the data augmentation service provided by the service server 100, each user may access a web page provided by the service server 100 through his or her own user terminal 200, or may install and provide a platform (application). However, for the convenience of description, the following description will be limited to the case where the data augmentation service is provided through the service platform.

Based on this platform, each user may transmit a service provision request to the service server 100 through the user terminal 200, and in response, may receive a training data set from the service server 100.

Meanwhile, the each user terminal 200 may be a computer, UMPC (Ultra Mobile PC), workstation, netbook, PDA (Personal Digital Assistants), portable computer, web tablet, wireless phone, mobile phone, smart phone, pad, smart watch, wearable terminal, e-book, PMP (portable multimedia player), portable game console, navigation device, black box or digital camera, other mobile communication terminal, etc., on which each user may install and execute multiple application programs (i.e., applications) desired. That is, the each user terminal 200 may be provided in various forms, and its form, number, and type are not limited.

As described above, the service provision system 1000 according to the present disclosure may be implemented through data/information transmission and reception between the service server 100 and the user terminal 200 based on network.

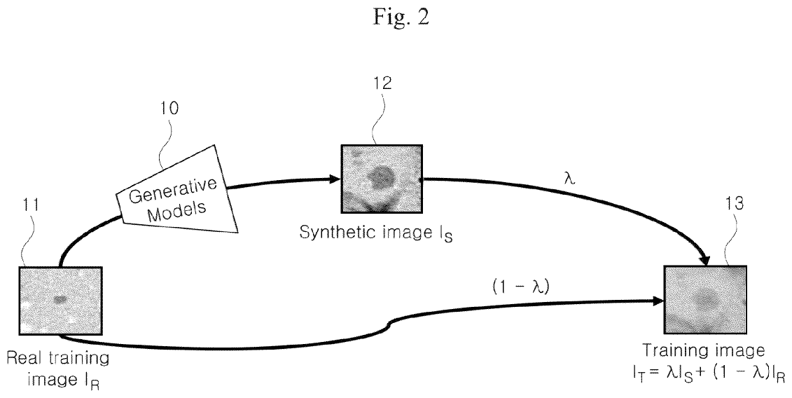

FIG. 2 is a diagram schematically illustrating a data processing procedure for augmenting data for medical image analysis based on artificial intelligence according to an embodiment of the present disclosure.

Referring to FIG. 2, Genmix may operate in two steps.

In the first step, synthetic data 12 is generated based on at least one real data 11 through a generative model 10. The generative model 10 may be pre-trained based on at least one of the StyleGAN scheme or the Ablated Diffusion Models (ADM) scheme.

Here, StyleGAN is a GAN architecture known for generating high-resolution, detailed images by finely controlling the style of the output. This architecture features a style-based generator that uses adaptive instance normalization (AdaIN) at each convolutional layer, allowing independent manipulation of global image features as well as details such as texture and color. The training process involves a generator that synthesizes images and a discriminator that distinguishes between real and generated images (i.e., fake images). Both networks are trained in an adversarial manner. The generator uses a mapping network to transform input latent vectors into an intermediate latent space, influencing the style of the generated images across multiple layers, providing fine-grained control over the output. StyleGAN excels at generating high-quality, realistic images by manipulating styles at multiple levels. However, issues such as mode collapse may limit image diversity.

Furthermore, ADM is a simplified version of the diffusion model that utilizes a diffusion process to generate high-quality images with enhanced diversity compared to existing models such as GANs. ADM generates images by progressively removing noise from random noise inputs over multiple stages, effectively reversing the process of data corruption to produce images that closely resemble the original data distribution. ADM maintains the core concept of the diffusion model, which incrementally adds noise to an image until it becomes random noise, then reverses the process to reconstruct the original image. This ADM simplifies the diffusion process by using a fixed noise schedule and a simplified denoising model. This reduced complexity enables faster training and inference times. ADM excels at generating diverse, high-quality images, making it a useful tool for data augmentation when image diversity is important. However, its high computational cost and complex learning process, which require careful hyperparameter tuning and significant resources, remain significant challenges.

Therefore, to address the limitations (problems) of StyleGAN or ADM described above, a second step is performed as follows.

In the second step, different sample data are mixed using a mixture model to improve the quality of the synthetic data and enable robust learning. Specifically, the MixUp method is applied to enable more robust learning and improve the quality of the synthetic images. Unlike the existing MixUp method that performs linear combination between identically sampled data, it mixes a sample data set composed of real data and synthetic data with a sample data set including real data. Here, the sample data set including real data and synthetic data is generated by combining real data and synthetic data according to a preset ratio.

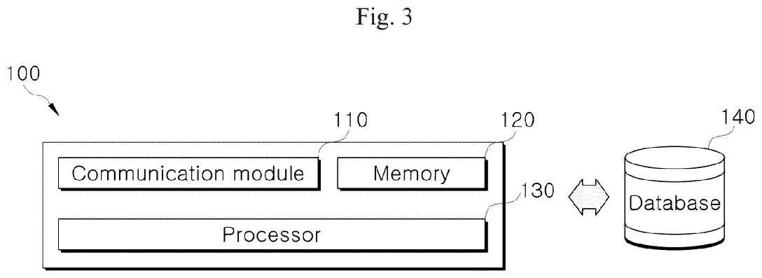

In the existing mixing model, while the real data is mixed between real data, or the synthetic data is mixed between synthetic data, as previously described, in the present disclosure, the mixed model is applied to different samples, that is, the real data and the data that is a mixture of the real data and the synthetic data. Accordingly, according to the present disclosure, the quality of synthetic data may be improved in small-scale data and class imbalance. FIG. 3 is a diagram schematically illustrating a configuration of a data augmentation device for medical image analysis based on artificial intelligence according to an embodiment of the present disclosure.

Referring to FIG. 3, the service server 100 according to an embodiment of the present disclosure may include at least one of a communication module 110, a memory 120, and a processor 130.

The communication module 110 may communicate with at least one of various terminals (devices), external storage (e.g., a database 140), an external server, or a cloud server.

Meanwhile, the external server or the cloud server may be configured to perform at least a portion of the role of the processor 130. That is, data processing or data operations may be performed on the external server or the cloud server, and the present disclosure does not place any particular limitations on such methods.

Meanwhile, the communication module 110 may support various communication schemes depending on the communication standards of the communication target (e.g., electronic device, external server, device, etc.).

For example, the communication module 110 may be configured to communicate with a communication target using at least one of WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), 5G (5th Generation Mobile Telecommunication), Bluetooth™, RFID (Radio Frequency Identification), IrDA (Infrared Data Association), UWB (Ultra-Wideband), ZigBee, NFC (Near Field Communication), Wi-Fi Direct, or Wireless USB (Wireless Universal Serial Bus) technologies.

Meanwhile, the memory 120 may be configured to store various information related to the present disclosure. In the present disclosure, the memory 120 may be provided in the device itself according to the present disclosure. Alternatively, at least a portion of the memory 120 may refer to at least one of the database (DB, 140 and the cloud storage (or cloud server). That is, the memory 120 may be sufficient as long as it is a space where information required for the device and method according to the present disclosure is stored, and it may be understood that there are no restrictions on the physical space. Accordingly, hereinafter, the memory 120, the database 140, the external storage, and the cloud storage (or cloud server) will not be separately distinguished, and will all be referred to as the memory 120.

The memory 120 may store a plurality of application programs (or applications) running on the service server 100, data for the operation of the service server 100, and commands. At least some of these application programs may be downloaded from an external server via wireless communication. Meanwhile, the application programs may be stored in at least one memory provided in the memory 120, installed on the service server 100, and driven to perform operations (or functions) by at least one processor stored in the memory 120 via the processor 130.

Meanwhile, at least one memory may include at least one type of storage medium including a flash memory type, a hard disk type, a multimedia card micro type, a card type memory (e.g., an SD or XD memory, etc.), random access memory (RAM), static random access memory (SRAM), read-only memory (ROM), electrically erasable programmable read/write (EEPROM), Programmable Read-Only Memory (PROM), a Programmable Read-Only Memory (PROM), a magnetic memory, a magnetic disk, and an optical disk. In addition, the memory may store information temporarily, permanently, or semi-permanently, and may be provided as a built-in or removable type.

Next, the processor 130 may be configured to control the overall operation of the device related to the present disclosure. The processor 130 may process signals, data, information, and the like input or output through the components described above, or provide or process appropriate information or functions to a user (including a manager, a worker, an inspector, etc.).

The processor 130 may include at least one Central Processing Unit (CPU) and perform functions according to the present disclosure.

Specifically, the processor 130 may collect at least one real data obtained by photographing a lesion site of each of a plurality of patients, and generate at least one synthetic data based on the at least one real data using a generative model. Thereafter, the processor 130 may perform mixing different sample data sets generated based on at least a portion of the at least one real data and the at least one synthetic data using a mixture model, and provide a training data set generated by the mixing.

Here, the different sample data sets may include a first sample data set including the at least one real data and a second sample data set including the each real data and the synthetic data corresponding to the real data.

In this case, the second sample data set may be a combination of the each real data and the synthetic data corresponding to the each real data according to a preset ratio. The preset ratio may be set and/or changed by a user of the user terminal 200 or an administrator of the service server 100, and is not limited to a specific ratio.

As described above, the generative model may be pre-trained based on at least one of a StyleGAN scheme or an Ablated Diffusion Models (ADM) scheme.

In addition, the mixture model may include at least one of Mixup, CutMix, or AugMix.

First, Mixup linearly interpolates between two images to generate the mixed image. This improves model robustness by smoothing the decision boundary and reducing overfitting in medical image analysis. A key strength of Mixup is that it encourages the model to correctly predict interpolated examples that fall between class extremes. However, Mixup may suffer from class imbalance, where minority class images are underrepresented, potentially leading to bias toward the dominant class. For example, Mixup may be applied to tasks such as chest X-ray analysis and diabetic retinopathy classification.

CutMix crops patches from one image and pastes them onto another image, while proportionally combining labels to generate the mixed image. While CutMix improves data diversity by generating a wider range of combinations, like Mixup, it may introduce noise into the data, reducing the information augmentation for certain tasks. For example, CutMix may be used for medical imaging tasks, such as detecting COVID-19 in CT smays.

AugMix also generates multiple chains, mixes them, and then mixes them back together with the original image. AugMix is a more advanced method that combines augmentation strategies while detecting consistency between the augmented image and the original image through Jensen-Shannon divergence loss. However, its complexity limits its accessibility to simple tasks or datasets that may not utilize high computational resources. For example, AugMix may be applied to improve classification performance in tasks such as skin lesion analysis.

Mixup, CutMix, and AugMix may be applied flexibly depending on the type of data, respectively.

That is, the processor 130 may selectively apply any one of Mixup, CutMix, or AugMix to perform a mixing operation, depending on the type of real data.

To build a pre-learning model in this way, the processor 130 collects at least one real data obtained by photographing the lesion area of each of a plurality of patients for a preset period of time and preprocesses each real data. For example, the processor 130 may perform preprocessing based on at least one of Min-Max scaling, standard scaling, MaxAbs, Normalizer, Quantile Transformer, or Power Transformer.

In addition, the specific operation of the processor 130 will be described below based on each drawing.

Furthermore, at least one component may be added or deleted depending on the performance of the components illustrated in FIG. 3. Furthermore, it will be readily apparent to those skilled in the art that the mutual positions of the components may be changed depending on the performance or structure of the device.

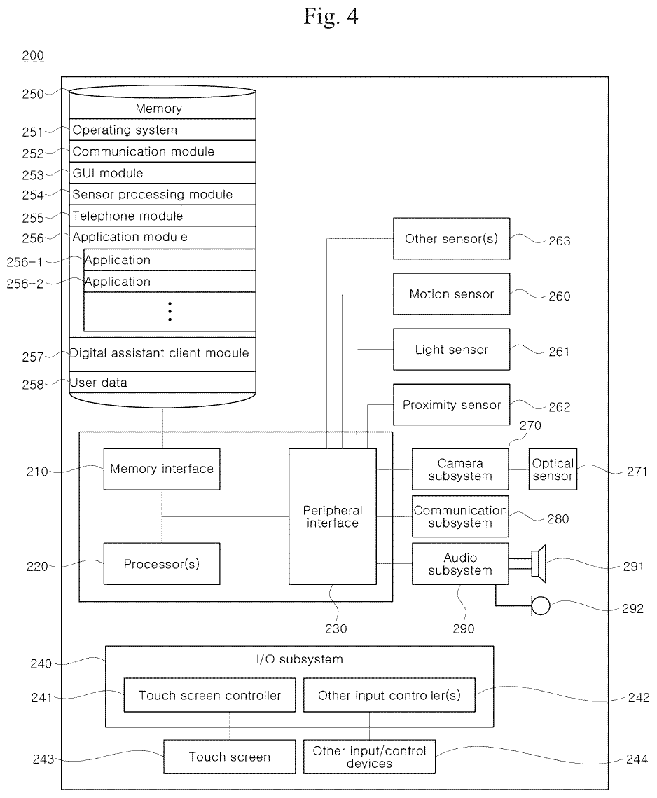

FIG. 4 is a diagram schematically illustrating a configuration of a user terminal utilizing a data augmentation service for medical image analysis based on artificial intelligence according to an embodiment of the present disclosure.

Referring to FIG. 4, the user terminal 200 may include a memory interface 210, one or more processors 220, and a peripheral interface 230. Various components within the user terminal 200 may be connected via one or more communication buses or signal lines.

The memory interface 210 may be connected to the memory 250 to transmit various data to the processor 220. Here, the memory 250 may include at least one type of storage medium among flash memory, hard disk, multimedia card micro, card-type memory (e.g., SD or XD memory), RAM, SRAM, ROM, EEPROM, PROM, network storage, cloud, and blockchain database.

In various embodiments, the memory 250 may store a web/app application or program for utilizing a data augmentation service. In addition, the memory 250 may store various types of information regarding at least one medical professional, patient, guardian, and the like, and may store various types of information acquired through the application or program.

In various embodiments, the memory 250 may store at least one of an operating system 251, a communication module 252, a graphical user interface module (GUI) 253, a sensor processing module 254, a telephone module 255, and an application module 256. Specifically, the operating system 251 may include instructions for processing basic system services and instructions for performing hardware operations. The communication module 252 may communicate with at least one of one or more other devices, computers, and servers. The graphical user interface module (GUI) 253 may process a graphical user interface. The sensor processing module 254 may process sensor-related functions (e.g., processing voice input received through one or more microphones 292. The telephone module 255 may process telephone-related functions. The application module 256 may perform various functions of a user application, such as electronic messaging, web browsing, media processing, navigation, imaging, and other processing functions. In addition, the user terminal 200 may store one or more software applications 256-1 and 256-2 (e.g., service applications) associated with a type of service in the memory 250.

In various embodiments, the memory 250 may store a digital assistant client module 257 (hereinafter, DA client module), and accordingly, may store commands for performing client-side functions of the digital assistant and various user data 258 (e.g., patient-tailored vocabulary data, preference data, other data such as the user's electronic address book, etc.).

Meanwhile, the DA client module 257 may obtain a user's voice input, text input, touch input, and/or gesture input through various user interfaces (e.g., I/O subsystem 240) provided in the user terminal 200.

In addition, the DA client module 257 may output data in audiovisual and tactile forms. For example, the DA client module 257 may output data consisting of a combination of at least two of voice, sound, notification, text message, menu, graphic, video, animation, and vibration. In addition, the DA client module 257 may communicate with a digital assistant server (not shown) using a communication subsystem 280.

In various embodiments, the DA client module 257 may collect additional information for the surrounding environment of the user terminal 200 from various sensors, subsystems, and peripheral devices to construct a context associated with the user input. For example, the DA client module 257 may provide context information along with the user input to the digital assistant server to infer the user's intent. Here, contextual information that may accompany user input may include sensor information, such as lighting, ambient noise, ambient temperature, images of the surrounding environment, video, and the like. For another example, the context information may include the physical state of the user terminal 200 (e.g., device orientation, device location, device temperature, power level, speed, acceleration, motion pattern, cellular signal strength, etc.). For another example, the context information may include information related to the software state of the user terminal 200 (e.g., processes running on the user terminal 200, installed programs, past and present network activity, background services, error logs, resource usage, etc.).

In various embodiments, the memory 250 may include added or deleted instructions. Furthermore, the user terminal 200 may also include additional components in addition to the components illustrated in FIG. 4, or may exclude some components.

The processor 220 may control the overall operation of the user terminal 200 and execute various commands to utilize the data augmentation service provided by the service server 100 by running applications or programs stored in the memory 250.

The processor 220 may correspond to a computing device such as a Central Processing Unit (CPU) or an Application Processor (AP). Furthermore, the processor 220 may be implemented in the form of an integrated chip (IC), such as a System on Chip (SoC) that integrates various computing devices that perform machine learning, such as an NPU (Neural Processing Unit).

In various embodiments, the processor 220 may provide various information and/or data to the user based on the platform through a user interface screen.

The peripheral interface 230 may be connected to various sensors, subsystems, and peripheral devices, and may provide data so that the user terminal 200 may perform various functions. Here, the user terminal 200 performing a certain function may be understood as being performed by the processor 220.

The peripheral interface 230 may receive data from a motion sensor 260, a light sensor (optical sensor) 261, and a proximity sensor 262, through which the user terminal 200 may perform orientation, light, and proximity detection functions, etc. For another example, the peripheral interface 230 may receive data from other sensors 263 (positioning system-GPS receiver, temperature sensor, biometric sensor), through which the user terminal 200 may perform functions related to the other sensors 263.

In various embodiments, the user terminal 200 may include a camera subsystem 270 connected to the peripheral interface 230 and an optical sensor 271 connected thereto, through which the user terminal 200 may perform various photographing functions, such as taking pictures and recording video clips. At this time, the camera subsystem 270 may be provided as a single photographing module including at least one photographing device. Here, the at least one photographing device may be configured to include at least one of a 2D camera, a 3D camera, a ToF (Time of Flight) camera, a light field camera, a stereo camera, an event camera, an infrared camera, a lidar sensor, or an array camera.

In various embodiments, the user terminal 200 may include a communication subsystem 280 connected to the peripheral interface 230. The communication subsystem 280 may be configured with one or more wired/wireless networks and may include various communication ports, radio frequency transceivers, and optical transceivers.

In various embodiments, the user terminal 200 includes an audio subsystem 290 connected to the peripheral interface 230, and the audio subsystem 290 includes one or more speakers 291 and one or more microphones 292, thereby enabling the user terminal 200 to perform voice-activated functions, such as voice recognition, voice duplication, digital recording, and telephone functions.

In various embodiments, the user terminal 200 may include an I/O subsystem 240 connected to the peripheral interface 230. For example, the I/O subsystem 240 may control a touch screen 243 included in the user terminal 200 via a touch screen controller 241.

For example, the touch screen controller 241 may detect a user's contact and movement or cessation of contact and movement using any one of a plurality of touch sensing technologies such as capacitive, resistive, infrared, surface acoustic wave technology, proximity sensor array, and the like. In another example, the I/O subsystem 240 may control other inputs. Other input/control devices 244 included in the user terminal 200 may be controlled through the controller(s) 242. For example, the other input controller(s) 242 may control one or more buttons, rocker switches, thumb wheels, infrared ports, USB ports, and pointer devices such as a stylus.

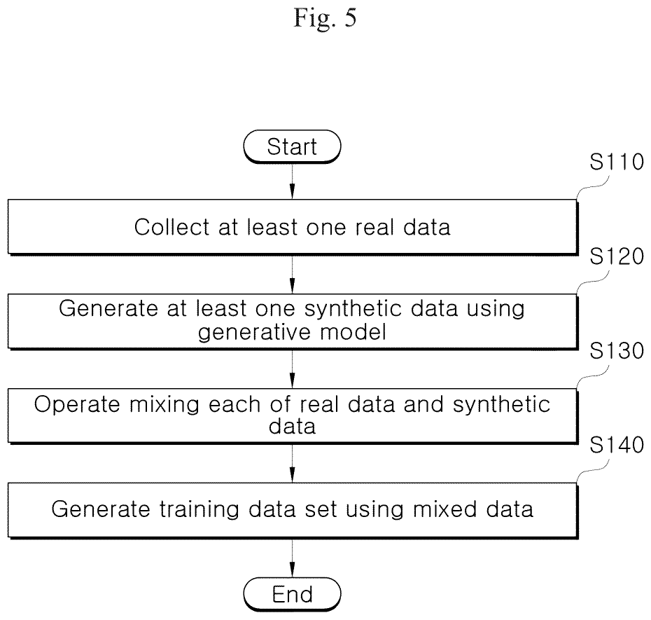

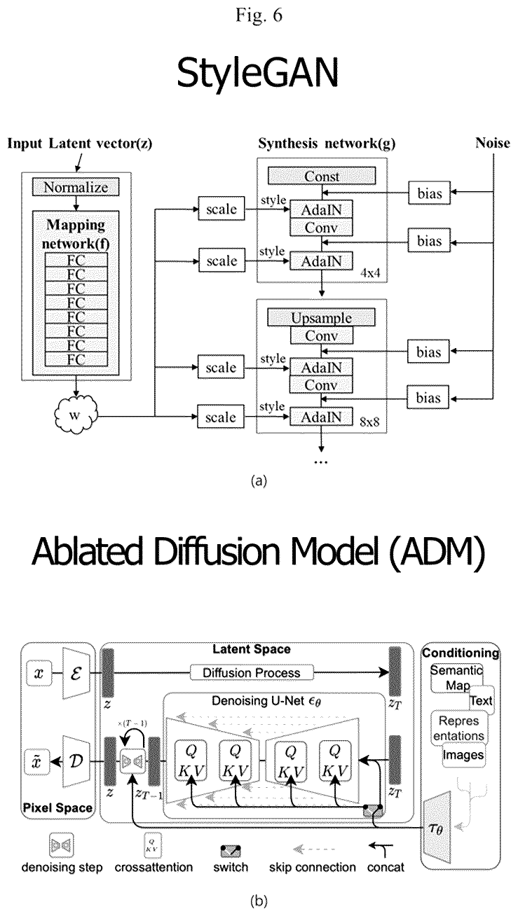

FIG. 5 is a diagram illustrating a data augmentation method for medical image analysis based on artificial intelligence according to an embodiment of the present disclosure. However, hereinafter, each step of FIG. 5 will be described in detail with reference to FIGS. 6 to 9.

Referring to FIG. 5, the service server 100 collects at least one real data obtained by photographing a lesion site of each of a plurality of patients (step S110).

Next, the service server 100 generates at least one synthetic data based on the at least one real data collected in step S110 using a generative model (step S120). At this time, the generative model may generate the synthetic data using either StyleGAN, as shown in (a) of FIG. 6 or ADM, as shown (b) of FIG. 6.

Thereafter, the service server 100 uses a mixture model to mix different sample data sets generated based on the at least one real data collected in step S110 and at least a portion of the at least one synthetic data generated in step S120 (step S130).

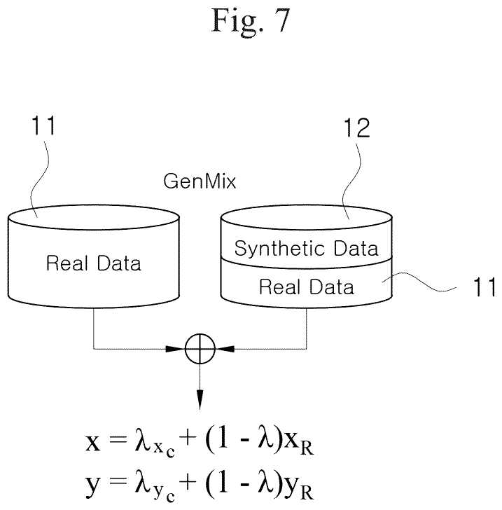

As illustrated in FIG. 7, the different sample data sets may include the first sample data set including the at least one real data 11, and the second sample data set including the each real data 11 and synthetic data 12 corresponding to the each real data.

That is, in step S130, a mixing operation is performed on the first sample data set and the second sample data set.

Meanwhile, although not illustrated in FIG. 5, the service server 100 may perform an operation of generating the first sample data set and the second sample data set prior to performing step S130.

Next, the service server 100 generates a training data set using at least one mixed data generated by performing the mixing operation in step S130, and provides the training data set to the user (step S140).

The training data set generated as such may be expressed as in [Equation 1] below.

$$x = λ {x}_{C} + ( 1 - λ ) {x}_{R} , y = λ {y}_{C} + ( 1 - λ ) {y}_{R} \qquad [ Equation 1 ]$$

Here, λ represents a Mixup coefficient determined by λ˜Beta(α, 1), a first sample data set including real data (xR, yR), and a second sample data set including the real data (xR, yR) and synthetic data (xC, yC) corresponding to the real data (xR, yR).

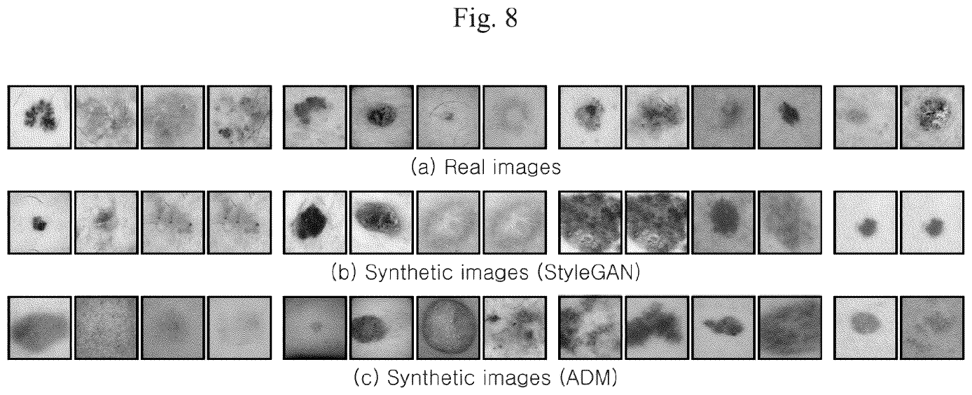

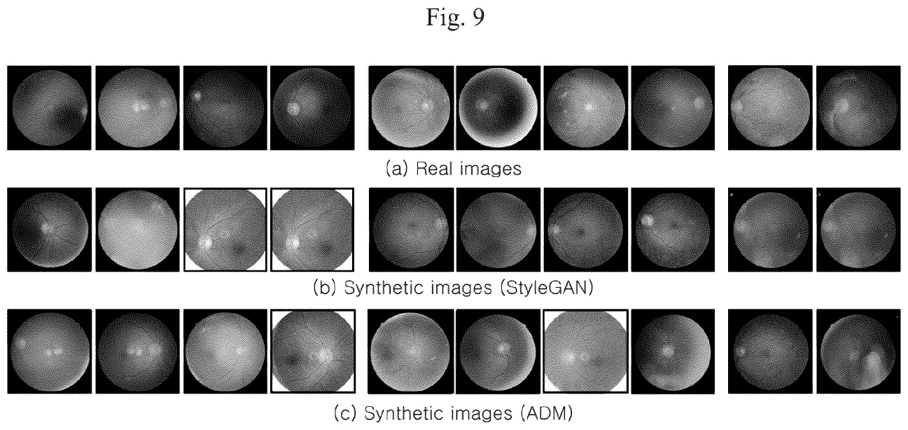

FIG. 8 is a diagram illustrating an example of real data and synthetic data of a DermaMNIST image according to an embodiment of the present disclosure, and FIG. 9 is a diagram illustrating an example of real data and synthetic data of a RetinaMNIST image according to an embodiment of the present disclosure.

FIG. 8 and FIG. 9 illustrate examples of the real data collected in step S110 and the synthetic data generated based on the real data collected in step S120, respectively. However, FIG. 8 is based on the DermaMNIST image set, while FIG. 9 is based on the RetinaMNIST image set.

Referring to FIG. 8, the real image shown in (a) features distinct imaging features associated with various skin lesion types, such as the uniform texture of benign lesions (BKL, DF, NV, VASC) and the irregular borders and uneven texture of malignant lesions (AKIEC, BCC, MEL).

Furthermore, the synthetic data generated by StyleGAN shown in (b) produces high-quality images that are highly similar to the real samples, effectively capturing the intricate details of these skin lesions. However, mode collapse also occurs, resulting in repetitive patterns in the synthetic images, limiting the diversity of the synthetic data.

On the other hand, the synthetic data generated by ADM shown in (c) produced a much wider variety of image patterns, enhancing the diversity of the dataset. However, the synthetic data generated by ADM on DermaMNIST exhibited a slight loss of detail, appearing slightly blurry compared to the images generated by StyleGAN.

Referring to FIG. 9, the real images shown in (a) generally depict various steps of diabetic retinopathy, with features such as microaneurysms, hemorrhages, and exudates, varying by severity grade.

Furthermore, as shown in (b), StyleGAN may accurately replicate these diagnostic features by generating synthetic images visually similar to the real images. However, as shown in FIG. 8 (b), mode collapse is observed in the synthetic images, and specific patterns are observed to be repeated across multiple samples.

On the other hand, the synthetic data generated by ADM shown in (c) exhibited a much broader range of visual patterns and effectively captured the diversity present in the real data set. For RetinaMNIST, the synthetic data generated by ADM did not suffer from the blurring issues observed in DermaMNIST, and maintained similar quality to images generated by StyleGAN.

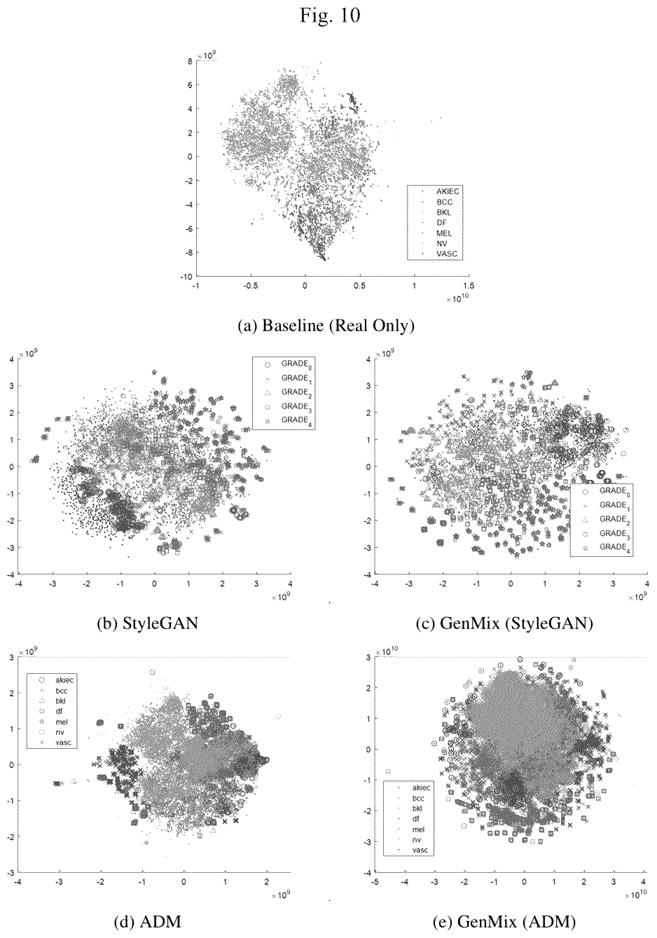

FIG. 10 is a diagram illustrating an example of a visualization of the feature distribution of a training data set generated using at least some of the real and the synthetic data of FIG. 8, according to an embodiment of the present disclosure.

Referring to FIG. 10, the baseline feature distribution revealed that the minority classes AKIEC and DF are closely clustered with the dominant classes BCC and MEL, increasing the possibility of misclassification. Furthermore, the positive class MEL overlapped with NV and BKL, further contributing to the relatively low F1 score of 65.5% despite being a dominant class. This feature overlap is directly correlated with the poor performance observed in these classes.

First, for the synthetic data generated by StyleGAN, mode collapse is evident due to the dense concentration of data points in specific regions, limiting the diversity and spread of the synthetic data across the feature space. However, using GenMix according to the present disclosure, a significant improvement is observed, with GenMix data more closely aligning with the distribution of the real data. This distribution helps reduce the overlap between classes, especially for the minority classes AKIEC and DF.

Meanwhile, the synthetic data generated by ADM shows a much closer alignment with the real data distribution compared to StyleGAN. This demonstrates the ability of the diffusion model to generate a more diverse set of patterns. However, limitations are observed in the clustering of the dominant class BCC, which exhibits significant overlap with other classes. GenMix according to the present disclosure, effectively addresses this problem by generating more distinct and well-separated clusters for BCC and improving the clarity of boundaries between classes.

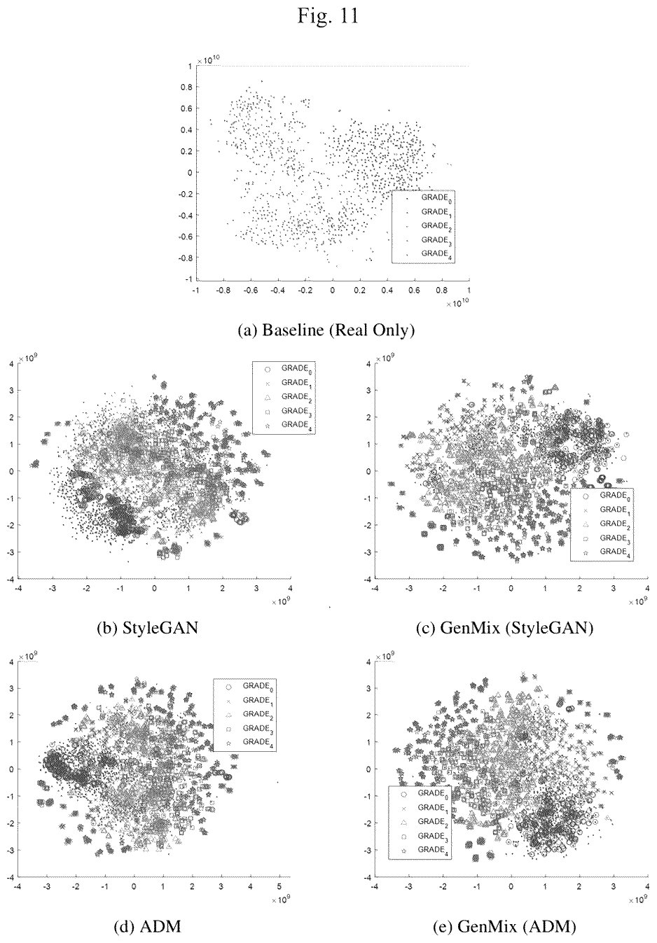

FIG. 11 is a diagram illustrating an example of visualizing the feature distribution of a training data set generated using at least some of the real data and the synthetic data of FIG. 9, according to an embodiment of the present disclosure.

Referring to FIG. 11, similar to DermaMNIST of FIG. 10, the synthetic data generated by StyleGAN exhibited mode collapse, with data points densely concentrated in specific regions, reducing the effective distribution of the synthetic data across the feature space. However, applying GenMix according to the present disclosure results in a more even distribution of the synthetic data, closely matching the distribution of the real data. This improved distribution reduces class overlap, particularly for minority classes G1 and G4, thereby improving overall classification performance.

Meanwhile, the t-SNE plot of the synthetic data generated by ADM again shows a distribution closely matching the real data, indicating that ADM may generate more diverse and realistic synthetic data than StyleGAN. However, there is still a notable overlap in the clusters for the major class G3, which may potentially lead to confusion with other classes. GenMix according to the present disclosure demonstrates that this problem may be effectively alleviated by generating clearer and better-defined clusters for the minor classes of G1 and G4 as well as G3.

As discussed above, the present disclosure proposes a data augmentation technique that improves medical image classification performance by combining a generative model (StyleGAN, ADM) and a mixed data augmentation (MixUp) approach, thereby solving the existing mode collapse problem and class imbalance problem, thereby improving accuracy in small and imbalanced data sets.

The program described above is configured such that the processor (CPU) of the computer is a device of the computer, so that the computer reads the program and executes the methods implemented as the program. The code may include code coded in a computer language such as C, C++, JAVA, or machine language that may be read through the interface. Such code may include functional code related to functions that define functions necessary to execute the above methods, and may include control code related to execution procedures necessary for the processor of the computer to execute the functions according to a predetermined procedure. In addition, such code may further include memory reference-related code regarding which location (address) of the internal or external memory of the computer should reference additional information or media necessary for the processor of the computer to execute the functions. In addition, if the processor of the computer needs to communicate with any other remote computer or server to execute the functions, the code may further include communication-related code regarding how to communicate with any other remote computer or server using the communication module of the computer, and what information or media should be sent and received during communication.

The storage medium refers to a medium that stores data semi-permanently and may be read by a device, rather than a medium that stores data for a short period of time, such as a register, cache, or memory. Specifically, examples of the storage medium include, but are not limited to, ROM, RAM, CD-ROM, magnetic tape, floppy disk, and optical data storage devices. That is, the program may be stored in various recording media on various servers accessible to the computer or in various recording media on the user's computer. In addition, the medium may be distributed across network-connected computer systems, so that computer-readable code may be stored in a distributed manner.

The steps of the method or algorithm described in connection with the embodiments of the present disclosure may be implemented directly in hardware, implemented as a software module executed by hardware, or implemented by a combination thereof. The software module may reside in random access memory (RAM), read only memory (ROM), erasable programmable ROM (EPROM), electrically erasable programmable ROM (EEPROM), a flash memory, a hard disk, a removable disk, CD-ROM, or any other form of computer-readable recording medium well known in the art to which the present disclosure pertains.

Although the embodiments of the present disclosure have been described above with reference to the accompanying drawings, those skilled in the art will understand that the present disclosure may be implemented in other specific forms without changing the technical spirit or essential characteristics thereof. Therefore, it should be understood that the embodiments described above are illustrative in all respects and not restrictive.

According to the present disclosure, a data augmentation technique is proposed that improves medical image classification performance by combining a generative model (StyleGAN, ADM) and a mixed data augmentation (MixUp) approach, thereby solving the existing mode collapse problem and class imbalance problem, thereby improving accuracy in small and imbalanced data sets.

According to the present disclosure, the effect of improving dementia cognitive status can be maximized by providing customized mission data according to the dementia status of the target dementia patient.

What is claimed is:

1. A device for data augmentation for medical image analysis based on artificial intelligence, comprising:
a communication module configured to communicate with an external device;
a memory configured to store at least one process for performing a data augmentation operation for medical image analysis based on artificial intelligence; and
a processor configured to perform the data augmentation operation for medical image analysis based on artificial intelligence according to the process,
wherein the processor is configured to:
collect at least one real data obtained by photographing a lesion site of each of a plurality of patients,
generate at least one synthetic data based on the at least one real data using a generative model,
perform mixing different sample data sets generated based on at least a portion of the at least one real data and the at least one synthetic data using a mixture model, and
provide a training data set generated by the mixing.

2. The device of claim 1,
wherein the different sample data sets include:
a first sample data set including the at least one real data and a second sample data set including the each real data and the synthetic data corresponding to the real data.

3. The device of claim 2,
wherein the second sample data set is a combination of the each real data and the synthetic data corresponding to the real data according to a preset ratio.

4. The device of claim 1,
wherein the generative model is pre-trained based on at least one of a StyleGAN scheme or an Ablated Diffusion Models (ADM) scheme.

5. The device of claim 1,
wherein the mixture model includes at least one of Mixup, CutMix, or AugMix.

6. The device of claim 5,
wherein the processor is configured to selectively apply one of Mixup, CutMix, and AugMix depending on the type of the real data.

7. The device of claim 1,
wherein the training data set is generated by the following <Equation 1>:
x=λx_{c}+(1−λ)x_{R},y=λy_{c}+(1−λ)y_{R} <Equation 1>
wherein, λ represents a Mixup coefficient determined by λ˜Beta(α, 1), xR and yR represents a first sample data set, and xc and y represent a second sample data set.

8. A method for data augmentation for medical image analysis based on artificial intelligence performed by a device, comprising:
collecting at least one real data obtained by photographing a lesion site of each of a plurality of patients;
generating at least one synthetic data based on the at least one real data using a generative model;
performing mixing different sample data sets generated based on at least a portion of the at least one real data and the at least one synthetic data using a mixture model; and
providing a training data set generated by the mixing.

9. The method of claim 8,
wherein the different sample data sets include:
a first sample data set including the at least one real data and a second sample data set including the each real data and the synthetic data corresponding to the real data.

10. The method of claim 9,
wherein the second sample data set is a combination of the each real data and the synthetic data corresponding to the real data according to a preset ratio.

11. The method of claim 8,
wherein the generative model is pre-trained based on at least one of a StyleGAN scheme or an Ablated Diffusion Models (ADM) scheme.

12. The method of claim 8,
wherein the mixture model includes at least one of Mixup, CutMix, or AugMix.

13. The method of claim 12,
wherein the processor is configured to selectively apply one of Mixup, CutMix, and AugMix depending on the type of the real data.

14. The method of claim 8,
wherein the training data set is generated by the following <Equation 1>:
$$x = λ {x}_{C} + ( 1 - λ ) {x}_{R} , y = λ {y}_{C} + ( 1 - λ ) {y}_{R} \qquad < Equation 1 >$$
wherein, λ represents a Mixup coefficient determined by λ˜Beta(α, 1), xR and yR represents a first sample data set, and xc and y represent a second sample data set.

15. A non-transitory computer-recordable recording medium storing a program for executing the method for data augmentation for medical image analysis based on artificial intelligence of claim 8.
